(19) United States
(12) Patent Application Publication
(10) Pub. No.: US 2015/0219484 A1
(43) Pub. Date: Aug. 6, 2015

(54) SIGHT GLASS ASSEMBLY

(71) Applicant: Joseph Dehner, West Des Moines, IA (US)

(72) Inventor: Joseph Dehner, West Des Moines, IA (US)

(21) Appl. No.: 14/611,453

(22) Filed: Feb. 2, 2015

Related U.S. Application Data
(60) Provisional application No. 61/935,048, filed on Feb. 3, 2014.

(51) Int. Cl. G01F 23/02

(52) U.S. Cl. CPC G01F 23/02

(57) ABSTRACT

The present invention relates to a sight glass assembly. The sight glass assembly includes a cover holding member that has an opening, sidewall, endwall. Positioned within the cover holding member is an O-ring and a glass or lens. The cover holding member is positioned against a farrel and a clamp is positioned around the farrel and the cover holding member and clamped to form a seal.

### CROSS REFERENCE TO RELATED APPLICATION

This application claims the benefit of U.S. Provisional Application No. 61/935,048 filed Feb. 3, 2014.

### BACKGROUND OF THE INVENTION

This invention is directed to an inspection or sight glass assembly for use in monitoring a process within a tank.

Sight glass assemblies used for inspection and/or process monitoring are well-known within the art. These assemblies are used in many industries, such as the food, beverage, oil and gas, pharmaceutical, or the like; for viewing and monitoring a process. Important characteristics of the assemblies are that they are able to maintain and withstand high pressure and heat, as well as provide a sanitary environment.

Exisiting sight glass assemblies are bulky and have a lot of parts. Some are bolted to a tank and are difficult to remove. Others screw onto the face of a tank but are expensive and have a limited viewing area. Others are clamped to a farrel, but the glass is not chemical resistant and the lens is susceptible to cracking or breaking. Most of the assemblies are not rated for sanitary use or rated to handle pressure. In addition, the parts of the different assemblies are not interchangeable, so if a manufacturer goes out of business, one cannot find replacement parts as the assemblies have specialized parts made for a particular component. Therefore, a need exists in the art for a device that addresses these needs.

An object of the invention is to provide a sight glass assembly that is durable.

A further object of the present invention is to provide a sight glass assembly that can handle pressure.

A still further object of the present invention is to provide a sight glass assembly that is sanitary.

A further object of the present invention is to provide a sight glass assembly that has improved viewing area.

A still further object of the present invention is to provide a sight glass assembly that is interchangeable.

### BRIEF DESCRIPTION OF THE DRAWINGS

FIG. 1 is a schematic side view of a sight glass assembly;

FIG. 2 is a schematic side view of a sight glass assembly;

FIG. 3 is a front view of a sight glass assembly;

FIG. 4 is a perspective view of a disassembled sight glass assembly; and

FIG. 5 is a perspective view of a sight glass assembly.

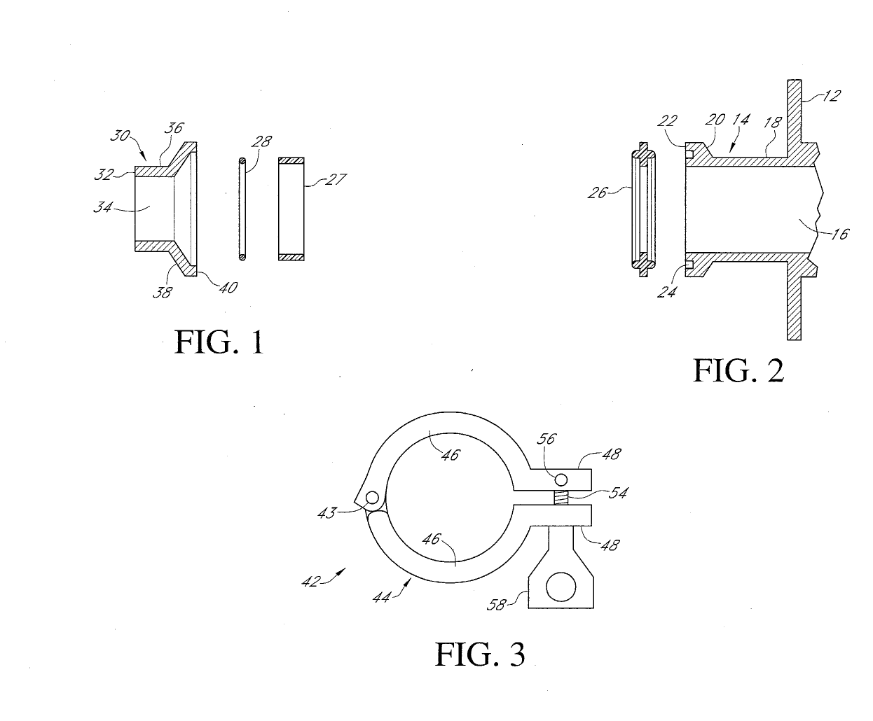

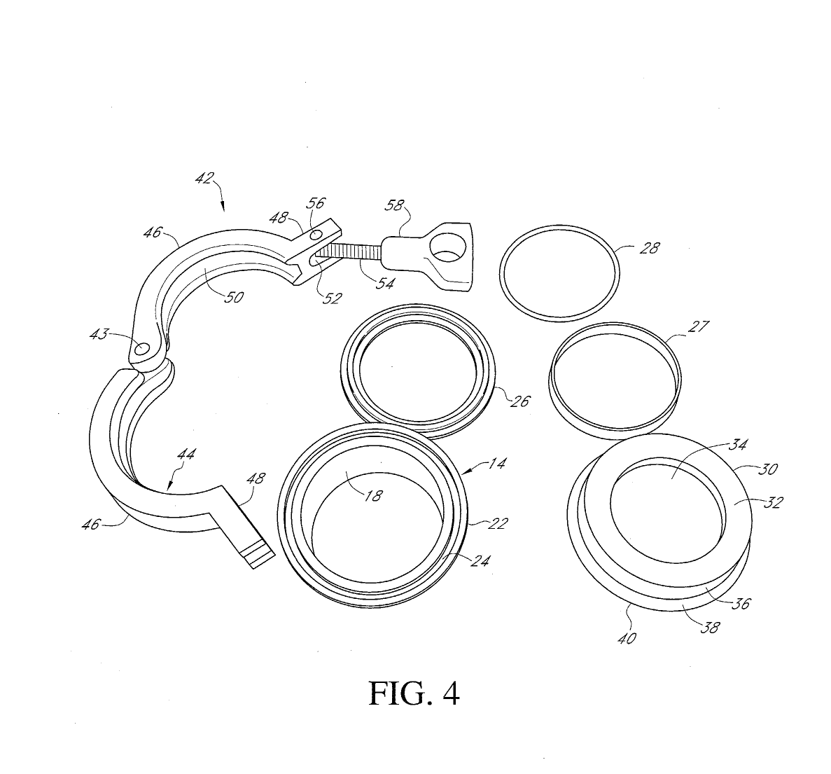

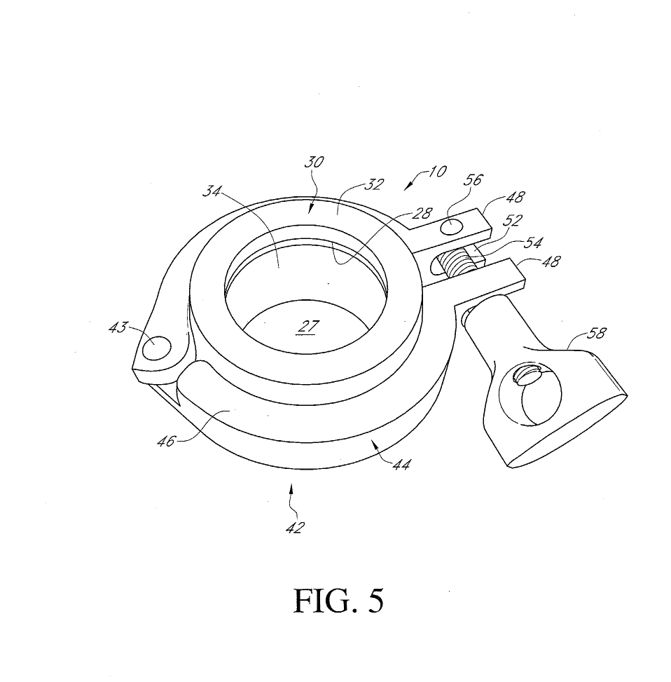

### SUMMARY OF THE INVENTION

The present invention relates to a sight glass assembly. The sight glass assembly includes a cover holding member that has an opening, sidewall, endwall. Positioned within the cover holding member is an O-ring and a glass or lens. The cover holding member is positioned against a farrel and a clamp is positioned around the farrel and the cover holding member and clamped to form a seal.

In some arrangements, the farrel and cover holding member both taper outwardly at ends that are then pressed against one another. The clamp has a groove that receives the ends of the farrel and cover holding member.

The clamp has two pivotally connected arcuate clamp arms that terminate in extending claws. The claws have a slot that receives a threaded screw that is connected to a pivot pin. The pivot pin receives a tightening bolt at the opposite end.

### DETAILED DESCRIPTION OF THE PREFERRED EMBODIMENTS

Referring to the Figures, a sight glass assembly 10 is used in relation to a tank 12 having a farrel 14 that fits over an opening 16 in the tank 12. The sight glass assembly 10 can also be used with any sutiable container or body. The farrel 14 is welded or threaded to the tank 12 and has a hollow shaft 18 that has a section 20 that tapers outwardly to an end 22. The end 22 has a groove 24 that is formed to receive a gasket 26.

The sight glass assembly 10 includes a glass or lens 27, a gasket or O-ring 28, and a cover holding member 30. The holding member 30 has an end wall 32 with an opening 34 and a sidewall 36. The depth of the sidewall 36 is sufficient to receive the glass 27 and O-ring 28, depending upon the application. The sidewall 36 has a section 38 that tapers outwardly to a flange or end 40.

In operation, the O-ring 28 and glass 27 are placed within the sidewall 36 of the holding member 30 so that the O-ring engages the endwall 32 to protect the glass 27 from the endwall 32. The holding member 20 is then aligned and pressed against the gasket 26 and the end 22 of the farrel 14 so that at least a portion of the holding member 20 is in contact with the gasket 26 and the glass 27 sits upon the gasket 26. In another arrangment, the gasket 26 contacts the glass 27 and not the holding member 20. A clamp 42 is then fitted over the tapered sections 20 and 38 of the farrel 14 and holding member 30 such that when the clamp is closed the ends 22 and 40 are squeezed together creating a seal.

The clamp 42 has a pair of clamp arms 44 that are pivotally connected about pivot pin 43 and that have an arcuate section 46 that terminate in an outwardly extending claw 48. Each of the arcuate sections 46 have a groove 50 formed to receive and press the ends 22 and 40 of the farrel 14 and the holding member 30. The claws 48 have slots 52 that receive a threaded screw 54. The threaded screw 54 is connected to one claw 48 by a pivot pin 56 and receives a threaded tightening bolt 58 at the opposite end. Once ends 20 and 40 are received within groove 50, the screw 54 is pivoted between slots 54 and bolt 58 is tightened to lock the clamp 42 in a closed or clamping position.

Therefore, a sight glass assembly 10 has been disclosed that has few parts, is interchangeable, has an improved viewing area, is durable, is sanitary, and can handle high pressure. The assembly is low in cost, provides a maximum viewing area, can be quickly disassembled, and improves upon the art.

From the above discussion and accompanying figures and claims it will be appreciated that the sight glass assembly 10 offers many advantages over the prior art. It will also be appreciated by those skilled in the art that other modifications could be made without parting from the spirit and scope of the invention and fall within the scope of the claims and are intended to be covered thereby.

What is claimed is:

1. A sight glass assembly comprising:
a cover holding member having an opening, a sidewall, and an end wall;
an O-ring positioned within the cover holding member adjacent the end wall;
a glass positioned within the cover holding member adjacent the O-ring;
a farrel positioned against the cover holding member; and
a clamp positioned around the farrel and the cover holding member, wherein the clamp forms a seal.

2. The sight assembly of claim 1 further comprising the sidewall having a section that tapers outwardly to an end.

3. The sight assembly of claim 1 further comprising the farrel having a hollow shaft that tapers outwardly to an end.

4. The sight assembly of claim 1 further comprising the farrel having a hollow shaft having a section that tapers outwardly to an end and the sidewall having a section that tapers outwardly, wherein the clamp is positioned around the end of the hollow shaft and the end of the sidewall.

5. The sight assembly of claim 4 wherein the when the clamp is closed the end of the hollow shaft and the sidewall are squeezed together to form the seal.

6. The sight assembly of claim 1 wherein the sidewall is of sufficient depth to receive the glass and the O-ring.

7. The sight glass assembly of claim 1 further comprising the farrel having a hollow shaft that fits over an opening in a tank.

8. The sight assembly of claim 1 wherein the O-ring engages the end wall and the glass engages the O-ring.

9. The sight assembly of claim 1 further comprising the farrel having a tapered section and a groove within the tapered section.

10. The sight assembly of claim 9 further comprising a gasket received within the groove.

11. The sight assembly of claim 10 wherein the glass sits upon the gasket.

12. The sight assembly of claim 1 further comprising the clamp having a pair of pivotally connected arcuate clamp arms.

13. The sight assembly of claim 12 further comprising the clamp arms terminating in an outwardly extending claws.

14. The sight assembly of claim 13 further comprising the claws having slots that receive a threaded screw.

15. The sight assembly of claim 14 wherein the threaded screw is connected to one claw by a pivot pin and receives a tightening bolt at the opposite end.

16. The sight assembly of claim 15 wherein when the clamp is positioned around the farrel and the cover holding member the threaded screw is pivoted between the slots and the bolt to lock the clamp in a clamping position.

17. The sight assembly of claim 12 further comprising the clamp arms having a groove formed to receive and press an end of the farrel and an end of the cover holding member.

18. A sight glass assembly comprising:
a cover holding member having an opening, a sidewall that terminates in a tapered end, and an end wall;
an O-ring positioned within the cover holding member adjacent the end wall;
a glass positioned within the cover holding member adjacent the O-ring;
a farrel having a hollow shaft that terminates in a tapered end; and
a clamp having a groove that receives the end of the farrel and the end of the cover holding member.
